(19) United States
(12) Patent Application Publication
(10) Pub. No.: US 2012/0314122 A1
(43) Pub. Date: Dec. 13, 2012

(54) PLASTIC LENS, PHOTOGRAPHING LENS, IMAGING DEVICE, AND PORTABLE DEVICE

(75) Inventor: Masatoshi Yamashita, Osaka (JP)

(73) Assignee: Panasonic Corporation, Osaka (JP)

(21) Appl. No.: 13/146,096

(22) PCT Filed: Dec. 22, 2010
(86) PCT No.: PCT/JP2010/007413

§ 371 Date: Jul. 25, 2011

(30) Foreign Application Priority Data
Jan. 13, 2010 (JP) 2010 004719

(51) Int. Cl. G02B 3/00; G02B 1/04; G03B 9/02; H04N 5/225; G02B 5/18

(52) U.S. Cl. 348/360; 359/642; 359/570; 396/505; 348/E05.031

(57) ABSTRACT

A plastic lens includes a flange portion on an outer circumference of a lens effective-diameter portion and manufactured by injecting a resin into a mold via a gate portion. The plastic lens is characterized by having a shape satisfying conditions of s/t≦0.61 and E.D/D≧0.4 when s [mm] and t [mm] represent a peripheral thickness, a central thickness of the lens effective-diameter portion, E.D [mm] represents a lens effective diameter, and D [mm] represents a lens diameter.

### TECHNICAL FIELD

The present invention relates to a plastic lens used in an optical device such as a camera or an optical pickup device, a photographing lens, an imaging device, and a portable device.

### BACKGROUND ART

This type of plastic lens is manufactured by allowing a resin such as a polycarbonate resin or a methacryl resin to flow into a mold. First, a mold corresponding to the shape of a plastic lens is prepared, the mold is attached to an injection molding machine, a molten resin is allowed to flow into a cavity from a gate portion as a resin injection channel disposed in the mold to fill the cavity, the resin is cooled and solidified, and the resultant is taken out of the mold. The taken-out plastic lens is circular as viewed in an optical axis direction but the gate portion is connected to a runner from a part of a flange portion on the outer circumference. Accordingly, the gate portion is cut as the final process and the resultant is taken out of the runner to complete the plastic lens.

However, when a part of the gate portion remains at the time of cutting, the plastic lens may not be attached to a lens holder. Even when it can be attached to the lens holder, it may not be centered on the lens holder. Accordingly, as a method of cutting the gate portion, a method of cutting a part of the flange portion connected to the gate portion along with the gate portion has been suggested (for example, see PTL 1). A method of cutting a gate portion more internal than a virtual outer circumferential surface of the flange portion in a plastic lens formed using a mold having a cavity shape in which a part of the flange portion is cut out and having the gate portion disposed in the cutout portion has also been suggested (for example, see PTL 2).

However, when the plastic lens manufactured by injection molding has a decreased size (decreased thickness) and a complex shape, it is known that internal strain can easily occur. Accordingly, it is important to solve such a problem in cameras for recent portable devices which often have complex shapes due to a requirement for an increase in image quality and a decrease in size.

In order to reduce the internal strain, the filling pressure of the resin can be lowered at the time of performing the injection molding. However, when the filling pressure of the resin is lowered, a sink mark may be formed on a lens surface due to filling failure and excellent shape accuracy may not be accomplished. In the injection molding, since the occurrence of the internal strain and the decrease in shape accuracy have a trade-off relationship, it is necessary to try different approaches so as to solve the problems simultaneously.

### CITATION LIST

### Patent Literature

[PTL 1] Japanese Patent Unexamined Publication No. 2001-272501
[PTL 2] Japanese Patent Unexamined Publication No. 2004-177609

### DISCLOSURE OF THE INVENTION

According to an aspect of the present invention, there is provided a plastic lens including a flange portion on an outer circumference of a lens effective-diameter portion and manufactured by injecting a resin into a mold via a gate portion, wherein the plastic lens is characterized by having a shape satisfying conditions of s/t≦0.61 and E.D/D≧0.4 when s [mm] and t [mm] represent a peripheral thickness, a central thickness of the lens effective-diameter portion, E.D [mm] represents a lens effective diameter, and D [mm] represents a lens diameter.

According to this configuration, even when a lens decreases in size (decreases in thickness) and has a complicated shape, it is possible to accomplish excellent shape accuracy and to reduce internal strain.

### BRIEF DESCRIPTION OF THE DRAWINGS

FIG. 1 is a longitudinal sectional view illustrating an imaging device employing a plastic lens according to an embodiment of the present invention.

FIG. 2A is a sectional view illustrating the plastic lens according to the embodiment of the present invention.

FIG. 2B is a plan view illustrating the plastic lens according to the embodiment of the present invention.

FIG. 3A is a front view illustrating a portable device according to an embodiment of the present invention.

FIG. 3B is a rear view illustrating the portable device according to the embodiment of the present invention.

### PREFERRED EMBODIMENTS FOR CARRYING OUT THE INVENTION

Hereinafter, a plastic lens, a photographing lens, an imaging device, and a portable device according to embodiments of the present invention will be described with reference to the accompanying drawings.

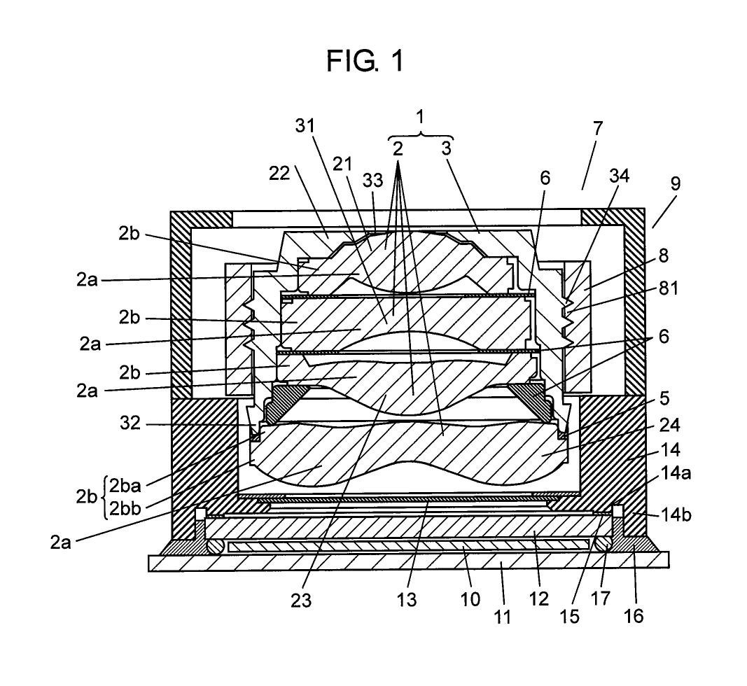

FIG. 1 shows imaging device 7 according to an embodiment of the present invention. As shown in FIG. 1, lens barrel 1 which is an element of imaging device 7 includes photographing lens 2 and lens holder 3 housing photographing lens 2. More specifically, lens barrel 1 includes photographing lens 2 including plural lenses each having flange portion (edge portion) 2b on the outer circumference of lens effective-diameter portion 2a and cylindrical lens holder 3 holding photographing lens 2 in the inner wall.

Photographing lens 2 includes plural sheets of, for example, four sheets of, concave-convex lenses and the outer sizes such as the diameter or the shapes of the lenses are different from each other. Specifically, A lens (hereinafter, referred to as first lens 21, second lens 22, third lens 23, and fourth lens 24 in the order going closer to an imaging plane) disposed closer to the imaging plane (imaging element 10) has a larger size (the outer size such as the diameter). Accordingly, the size of first lens 21 disposed farthest from the imaging plane is the smallest and the size of fourth lens 24 disposed closest to the imaging plane is the largest. Fourth lens 24 includes an insertion portion 2ba smaller than the inner diameter of holding portion 32 to be described of lens holder 3 and a pressing portion 2bb being formed continuously from insertion portion 2ba, being larger than the inner diameter of holding portion 32, and having an opposite surface at a position separated from the end surface (the end surface of lens holder 3 close to the imaging plane) of holding portion 32 in flange portion 2b, and the outer diameter of flange portion 2b of fourth lens 24 is smaller than the outer diameter of holding portion 32.

Lens holder 3 is configured to house plural (four in the drawing) photographing lenses 2, support portion 31 entirely or partially supporting flange portion 2b on one side (the subject side) of first lens 21 in the optical axis direction is formed at one end (an end facing the subject), and holding portion 32 entirely or partially facing flange portion 2b on the other side (the imaging plane side) of fourth lens 24 is formed at the other end (an end facing the imaging plane).

Opening 33 is disposed on the top of lens holder 3. Opening 33 serves as an aperture diaphragm of photographing lenses 2. Male screw 34 (to be screwed to outer holder 8 to be described later) is formed on the outer surface of lens holder 3.

Photographing lenses 2 are housed in lens holder 3 from support portion 31 to holding portion 32. Specifically, photographing lenses 2 and light-blocking plates (spacers) 6 are housed inside lens holder 3, and a gap (space) is formed in a part between flange portions 2b of photographing lenses 2 (excluding fourth lens 24) and the inner circumferential surface of lens holder 3, as shown in the right half of FIG. 1, by cutout portions (cutout portions formed by one method described in “BACKGROUND ART”) formed in flange portions 2b of photographing lenses 2 (excluding fourth lens 24).

Among photographing lenses 2, first lens 21 is housed and mounted in lens holder 3, so that the top surface of flange portion 2b thereof comes in contact with the bottom surface of support portion 31 of lens holder 3 and the lens surface of lens effective-diameter portion 2a excluding flange portion 2b maintains a predetermined distance greater than 0 μm and equal to or less than 50 μm from the bottom surface of lens holder 3. Fourth lens 24 is mounted in lens holder 3 so that insertion portion 2ba is inserted into holding portion 32. In this inserted state, since pressing portion 2bb formed continuously from insertion portion 2ba and larger than the inner diameter of holding portion 32 is separated from the end surface of holding portion 32, a recessed portion is formed by the tip end of lens holder 3 and flange portion 2b of fourth lens 24. Specifically, the recessed portion is an annular recessed portion formed concave by holding portion 32 of lens holder 3 and insertion portion 2ba and pressing portion 2bb of fourth lens 24, and adhesive 5 is filled in the recessed portion to fix fourth lens 24 to lens holder 3.

When the gap between the bottom surface of lens holder 3 and lens effective-diameter portion 2a is greater than 50 μm, flare is generated due to stray light (unnecessary light). When the gap is equal to or less than 0 μm, lens effective-diameter portion 2a is damaged to generate dust. Accordingly, the gap is set to be larger than 0 μm and equal to or less than 50 μm.

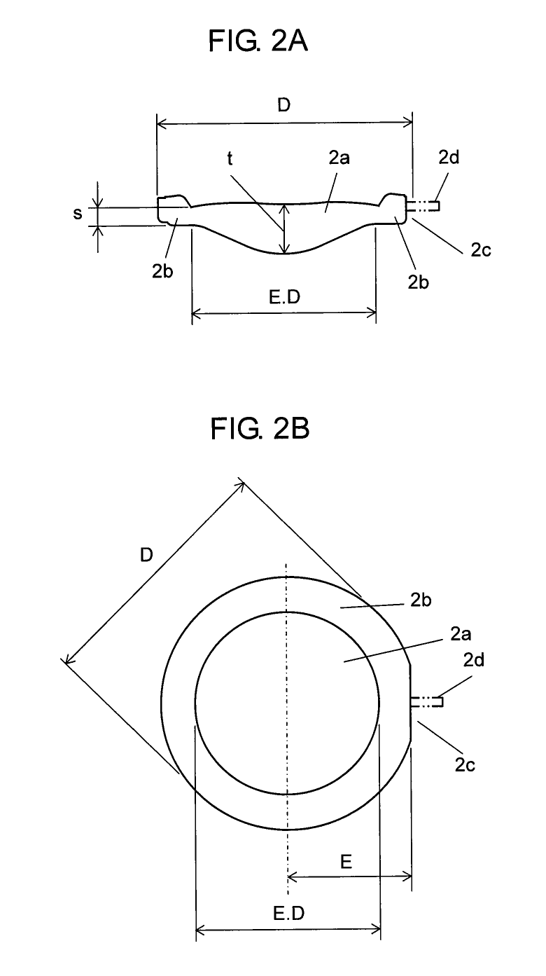

Here, third lens 23 which is a feature of this embodiment will be described below. FIG. 2A is a sectional view of third lens 23 and FIG. 2B is a plan view thereof. As described above, third lens 23 includes lens effective-diameter portion 2a and flange portion 2b on the outer circumference of lens effective-diameter portion 2a, similarly to the other lenses.

Third lens 23 is a convex lens having a circular shape in a plan view and having a diameter (outer diameter) defined as D [mm], and lens effective-diameter portion 2a thereof has a diameter (effective lens diameter) E.D [mm], a peripheral thickness (thickness of the thinnest portion) s [mm], and a central thickness (thickness of the center) t [mm]. Third lens 23 has cutout portion 2c (the distance from the center to the cutout portion 2c is E [mm]) at a part of the outer circumference of flange portion 2b and a gate portion 2d is disposed in the cutout portion 2c.

Table 1 shows the test results with the change in parameters. The internal strain is checked by the use of a crossed Nicol method. As a result, the internal strain is recognized from the lenses with lens type Nos. 3 and 7, and the internal strain is not recognized from the lenses with the other lens type Nos. 1, 2, 4 to 6, and 8.

TABLE 1

| | Thickness of | Thickness of | Outer | Effective | | | |
|---|---|---|---|---|---|---|---|
| Lens | Center | Thinnest | Diameter | Diameter | Internal | Ratio | Ratio |
| Type | Portion t | Portion s | D | E.D | strain | s/t | E.D/D |
| NO. 1 | 0.856 | 0.522 | 4.1 | 1.62 | OK | 0.61 | 0.40 |
| NO. 2 | 0.756 | 0.373 | 4.75 | 2.632 | OK | 0.49 | 0.55 |
| NO. 3 | 0.645 | 0.9 | 5.5 | 4.07 | NG | 1.40 | 0.74 |
| NO. 4 | 1.094 | 0.65 | 4 | 1.91 | OK | 0.59 | 0.48 |
| NO. 5 | 0.952 | 0.338 | 4.75 | 3.402 | OK | 0.36 | 0.72 |
| NO. 6 | 0.736 | 0.425 | 5.66 | 5.162 | OK | 0.58 | 0.91 |
| NO. 7 | 0.961 | 0.411 | 4.1 | 1.588 | NG | 0.43 | 0.39 |
| NO. 8 | 0.725 | 0.436 | 4.1 | 2.286 | OK | 0.60 | 0.56 |

The reason of non-recognition of the internal strain is considered as follows. Accordingly, by designing third lens 23 so as to satisfy the following relational expressions, it is possible to accomplish excellent shape accuracy and to prevent the internal strain from being formed (in cutout portion 2c), even when the lens decreases in size and has a complicated shape.

s/t≦0.61 Expression 1

E.D/D≧0.4 Expression 2

Various resin materials can be selected as the material of third lens 23 and several resin materials are tested. Table 2 shows the test results with the change in various resin materials. Resin material A is ZEONEX 480R (product name) made by Nippon Zeon Co., Ltd., resin material B is ZEONEX E48R (product name), and resin material C is ZEONEX F52R (product name), all of which are low-dispersion resin materials. Resin material D is OKP4 (product name) made by Osaka Gas and Chemicals Co., Ltd., resin material E is PC AD-5503 (product name) made by Teijin Chemicals Ltd., and resin material F is SP-1516 (product name) made by Teijin Chemicals Ltd., all of which are high-dispersion resin materials.

As described above, the internal strain is checked by the use of the crossed Nicol method. As a result, the internal strain is recognized from the lenses manufactured using resin materials A and E and the internal strain is not recognized from the lenses formed of the other resin materials B to D and F. Refractive index nD is a refractive index with respect to the D ray (587.6 nm). Abbe number υd is expressed by (nD−1)/(nF−nC), where the refractive index with respect to the F ray (486.1 nm) is nF and the refractive index with respect to the C ray (656.3 nm) is nC. Flexural strength σb [MPa] means the maximum shear stress generated just before a test piece is cracked, damaged, or ruptured in the bending test. Bending elastic modulus e [MPa] is an elastic modulus calculated using a load-deflection curve acquired in three-point bending and four-point bending tests of a typical material bending test. Tensile extension λ [%] is a value obtained by expressing the coefficient of extension at the time of rupture in percentage and is measured in a tensile test.

TABLE 2

| | Low-dispersion Resin | | | High-dispersion Resin | | |
|---|---|---|---|---|---|---|
| Resin Material | A | B | C | D | E | F |
| Refractive Index nD | 1.5247 | 1.53113 | 1.5345 | 1.6074 | 1.58547 | 1.6142 |
| Abbe Number υd | 56.4 | 55.8 | 55.6 | 26.7 | 29.9 | 26.0 |
| Flexural Strength | 100 | 125 | 104 | 120 | 96 | 124 |
| σb (MPa) | | | | | | |
| Bending Elastic | 2143 | 2449 | 2755 | 2700 | 2400 | 3320 |
| Modulus e (MPa) | | | | | | |
| Tensile Extension λ | 40 | 10 | 2 | 9 | 80 | 7 |
| (%) | | | | | | |
| Internal Strain | NG | OK | OK | OK | NG | OK |

The reason of non-recognition of the internal strain is considered as follows. Accordingly, by forming third lens 23 out of a resin material satisfying the following relational expressions, it is possible to further prevent the internal strain from being formed.

26.0≦υd≦55.8 Expression 3

1.53≦nD≦1.62 Expression 3′

104≦σb≦125 Expression 4

The reason of non-recognition of the internal strain is considered as follows. Accordingly, by forming third lens 23 out of a resin material satisfying the following relational expression, it is possible to further prevent the internal strain from being formed.

2≦λ≦10 Expression 5

In this embodiment, third lens 23 satisfies 3.5 mm≦D≦6.0 mm, 2.9 mm≦E.D≦5.4 mm, 0.3 mm≦s≦0.5 mm, 0.7 mm≦t≦1.0 mm, and 1.75 mm≦E≦2.9 mm.

In addition to lens barrel 1 (photographing lenses 2 and lens holder 3), imaging device 7 includes body 9, imaging element 10, substrate 11 on which imaging element 10 is mounted, glass plate 12 covering imaging element 10, and infrared cut-off filter 13. Body 9 includes cylindrical outer holder 8 housing photographing lenses 2 with lens holder 3 interposed therebetween. Imaging element 10 is disposed at a position separated by a predetermined distance from fourth lens 24, includes a light-receiving portion at the center thereof, converts an optical signal corresponding to a subject into an image signal, and outputs the image signal. Body 9 includes outer holder 8 holding lens holder 3 and support portion 14 disposed close to outer holder 8 so as to support outer holder 8. Outer holder 8 has a cylindrical shape and female screw 81 is formed on the inner surface. Male screw 34 of lens holder 3 is screwed to female screw 81 of outer holder 8.

Support portion 14 includes positioning portion 14a positioning lens holder 3, which is held in outer holder 8, and photographing lenses 2 in the vertical direction and protrusion 14b protruding toward imaging element 10 (or substrate 11) (to the downside).

Positioning portion 14a is formed on a plane having a predetermined area. The outer circumference of positioning portion 14a has a rectangular shape in a plan view. Positioning portion 14a positions photographing lenses 2 relative to imaging element 10 at a position closer to the outer circumferential surface than the light-receiving portion of imaging element 10. Specifically, positioning portion 14a comes in contact with the surface (the top surface) of glass plate 12 located on imaging element 10. Positioning portion 14a is fixed to glass plate 12 with adhesive 15 having low viscosity interposed therebetween to accomplish high positioning precision.

Protrusion 14b is fixed to the surface (the top surface) of substrate 11 with adhesive 16 interposed therebetween. A part of adhesive 16 is interposed between protrusion 14b and glass plate 12. In this way, since adhesive 16 having higher viscosity than that of adhesive 15 is interposed between protrusion 14b and glass plate 12, it is possible to effectively prevent the positioning shift of outer holder 8.

Imaging element 10 is fixed to the bottom surface of glass plate 12. The bottom surface of glass plate 12 is fixed to substrate 11 with connecting portion 17 interposed therebetween.

Infrared cut-off filter 13 is disposed between fourth lens 24 and glass plate 12. Specifically, infrared cut-off filter 13 is fixed to support portion 14 disposed closer to outer holder 8.

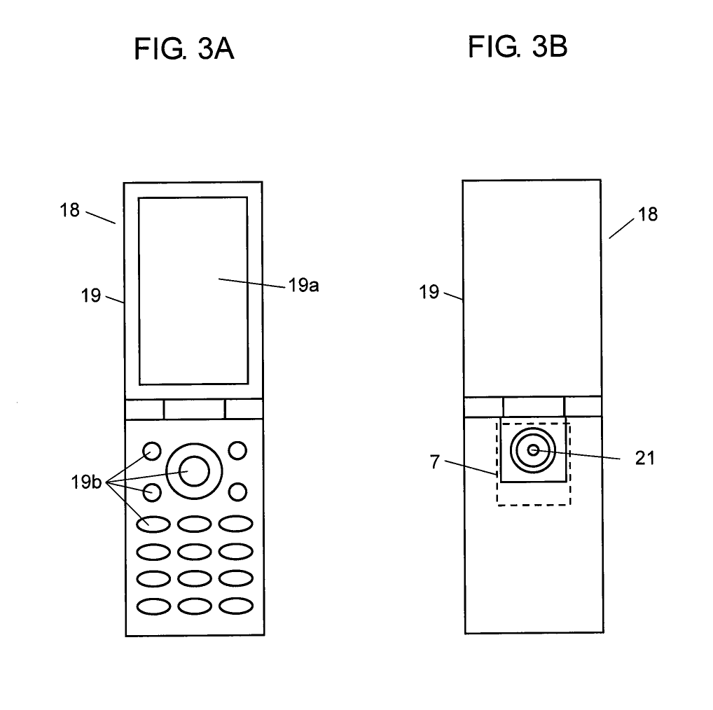

Portable device 18 having imaging device 7 will be described below. FIG. 3A is a front view of portable device 18 and FIG. 3B is a rear view thereof. Portable device 18 is, for example, a camera-attached mobile phone and includes body case 19, display 19a mounted on body case 19, operation unit 19b, and imaging device 7.

Body case 19 includes two rectangular plate bodies which are foldable, and short sides of two plate bodies are connected to each other. Specifically, the connected sides can be bent in one direction by a hinged link and can be folded so that one surface of one plate body faces one surface of the other plate body. More specifically, display 19a is disposed on the inner surface of one plate body of the body case 19 and operation unit 19b is disposed on the inner surface of the other plate body. The body case 19 is folded so that the surface mounted with display 19a and the surface mounted with operation unit 19b face each other closely. Display 19a is, for example, a rectangular liquid crystal screen and a picture corresponding to the operation of the mobile phone is displayed thereon. Operation unit 19b is used to operate the functions of the mobile phone and includes circular and elliptical buttons. Imaging device 7 is the same as described above and is disposed in body case 19. Specifically, opening 33 (first lens 21) of lens holder 3 is disposed on the opposite surface of the surface mounted with operation unit 19b in the body case 19.

The plastic lens, the imaging device, and the portable device according to the invention are not limited to the above-mentioned embodiment, but may be modified in various forms such as an AF digital camera, a PC camera, a monitoring camera, and an optical pickup device without departing from the concept of the invention.

For example, photographing lenses 2 include four lenses in the above-mentioned embodiment, but the number of lenses may not be four and may be, for example, two or three. Although it has been described that third lens 23 satisfies Expressions 1 to 4, the other lenses may satisfy the expressions.

One surface of the lens surfaces of lens effective-diameter portion 2a may include a diffractive element surface and the diffractive element surface may be set to satisfy f (doe)/f>30. As a result, by weakening the power of diffraction (increasing the focal distance) to reduce the orbicular zone number in lens effective-diameter portion 2a, it is possible to suppress the flare due to light of diffraction-unnecessary order.

As the resin material of the plastic lens, a low-dispersion resin material as well as the high-dispersion resin material may be employed. Accordingly, it is possible to further suppress the internal strain of the plastic lens.

### INDUSTRIAL APPLICABILITY

The plastic lens, the photographing lens, the imaging device, and the portable device according to the invention can be used for applications requiring for accomplishing excellent shape accuracy and reducing internal strain even with a small size and a complicated shape by setting the shapes and sizes thereof to suitable ranges.

### DESCRIPTION OF REFERENCE NUMERALS AND SIGNS

1: lens barrel
2: photographing lens
2a: lens effective-diameter portion
2b: flange portion
2ba: insertion portion
2bb: pressing portion
2c: cutout portion
2d: gate portion
3: lens holder
5, 15, 16: adhesive
6: light-blocking plate (spacer)
7: imaging device
8: outer holder
9: body
10: imaging element
11: substrate
12: glass plate
13: infrared cut-off filter
14, 31: support portion
14a: positioning portion
14b: protrusion
17: connecting portion
18: portable device
19: body case
19a: display
19b: operation unit
21: first lens
22: second lens
23: third lens
24: fourth lens
32: holding portion
33: opening
34: male screw
D: outer diameter (lens diameter)
E.D: diameter of lens effective-diameter portion (lens effective diameter)
s: peripheral thickness of lens effective-diameter portion (thickness of thinnest portion)
t: central thickness of lens effective-diameter portion (thickness of center portion)

1. A plastic lens comprising a flange portion on an outer circumference of a lens effective-diameter portion and manufactured by injecting a resin into a mold via a gate portion,
wherein the plastic lens is characterized by having a shape satisfying conditions of s/t≦0.61, E.D/D≧0.4 and s≦0.65 when s [mm] and t [mm] represent a peripheral thickness and a central thickness of the lens effective-diameter portion, E.D [mm] represents a lens effective diameter, and D [mm] represents a lens diameter.

2. (canceled)

3. The plastic lens of claim 1, wherein the plastic lens is formed of a resin material satisfying conditions of 26.0≦υd≦55.8 and 104≦σb≦125 when υd represents an Abbe number and σb [MPa] represents a flexural strength.

4. The plastic lens of claim 1, wherein the plastic lens is formed of a resin material satisfying conditions of 1.53≦nD≦1.62 and 104σb≦125 when nD represents a refractive index and σb [MPa] represents a flexural strength.

5. The plastic lens of claim 1, wherein the resin is a low-dispersion resin material.

6. The plastic lens of claim 1, wherein the lens effective-diameter portion has a diffractive element surface formed on one of lens surfaces, and the diffractive element surface satisfies a condition of f (doe)/f>30.

7. A photographing lens comprising a diaphragm and one or more lenses from a subject side to an imaging plane side,
wherein at least one of the one or more lenses is the plastic lens of claim 1.

8. An imaging device comprising:
an imaging element for converting an optical signal corresponding to a subject into an image signal and outputting the image signal; and
a photographing lens for forming an image of the subject on an imaging plane of the imaging element,
wherein the photographing lens includes the photographing lens of claim 7.

9. A portable device comprising the imaging device of claim 8.

10. The plastic lens of claim 3, wherein the lens effective-diameter portion has a diffractive element surface formed on one of lens surfaces, and the diffractive element surface satisfies a condition of f (doe)/f>30.

11. The plastic lens of claim 4, wherein the lens effective-diameter portion has a diffractive element surface formed on one of lens surfaces, and the diffractive element surface satisfies a condition of f (doe)/f>30.

12. The plastic lens of claim 5, wherein the lens effective-diameter portion has a diffractive element surface formed on one of lens surfaces, and the diffractive element surface satisfies a condition of f (doe)/f>30.
